(19) United States
(12) Patent Application Publication
(10) Pub. No.: US 2025/0230369 A1
(43) Pub. Date: Jul. 17, 2025

(54) REFINING APPARATUS AND REFINING METHOD OF WASTE PLASTIC PYROLYSIS OIL

(71) Applicants: SK INNOVATION CO., LTD., Seoul (KR); SK GEO CENTRIC CO., LTD., Seoul (KR)

(72) Inventors: Heejung JEON, Daejeon (KR); Okyoun KIM, Daejeon (KR); Kayoung KIM, Daejeon (KR); Youngmoo PARK, Daejeon (KR); Howon LEE, Daejeon (KR)

(21) Appl. No.: 18/708,213

(22) PCT Filed: Nov. 24, 2022
(86) PCT No.: PCT/KR2022/018736

§ 371 Date: May 8, 2024

(30) Foreign Application Priority Data
Nov. 26, 2021 (KR) 10-2021-0165915

(51) Int. Cl. C10G 49/04; B01J 8/04; B01J 23/28; B01J 27/19; B01J 35/63; B01J 35/64; B01J 35/66

(52) U.S. Cl. CPC C10G 49/04; B01J 8/0453; B01J 8/0492; B01J 23/28; B01J 27/19; B01J 35/633; B01J 35/635; B01J 35/638; B01J 35/647; B01J 35/66; B01J 2208/025; C10G 2300/1003

(57) ABSTRACT

Provided is a refining apparatus of a waste plastic pyrolysis oil including a reactor where a waste plastic pyrolysis oil is introduced and hydrotreated, wherein the reactor includes Area 1 including a hydrotreating catalyst having a Mo content of 1 to 15 wt % with respect to the total weight; and Area 2 including a hydrotreating catalyst having a Mo content of 5 to 40 wt % and a Ni or Co content of 4 to 50 wt % with respect to the total weight, and the waste plastic pyrolysis oil is refined by passing through Area 1 and Area 2 sequentially.

### TECHNICAL FIELD

The present disclosure relates to a refining apparatus and a refining method of a waste plastic pyrolysis oil.

### BACKGROUND ART

Waste plastics, which are manufactured using petroleum as a raw material, have a low recyclability and are mostly disposed of as garbage. Since it takes a long time to decompose the wastes in its natural state, the waste pollutes the soil and causes serious environmental pollution. As a method of recycling waste plastics, the waste plastics may be pyrolyzed and converted into a usable oil fraction, which is referred to as a waste plastic pyrolysis oil.

However, since a pyrolysis oil obtained by pyrolyzing waste plastics has a high content of impurities such as chlorine, nitrogen, and metal as compared with oil fractions manufactured from crude oil by a common method, it may not be directly used as high value-added petrochemical products such as gasoline and diesel oil and should go through a refining process.

For example, as a refining method for removing impurities such as chlorine, nitrogen, and metal contained in the waste plastic pyrolysis oil, a dechlorination/denitrification method by reacting the waste plastic pyrolysis oil and hydrogen in the presence of a hydrotreating catalyst, a method of removing chlorine contained in the waste plastic pyrolysis oil by adsorption using a chlorine adsorbent, or the like is known.

The waste plastic pyrolysis oil is a mixture of hydrocarbon oil fractions having various boiling points and various molecular weight distributions, and the composition or the reaction activity of impurities in the pyrolysis oil may vary with the boiling point and the molecular weight distribution characteristics. When a refining process is performed on a waste plastic pyrolysis oil whole feed, an excessive hydrotreatment is performed under excessive operating conditions (high temperature, high pressure) due to a high content of impurities in the waste plastic pyrolysis oil, which activates the production of an ammonium salt (NH₄Cl). An ammonium salt (NH₄Cl) produced inside a reactor causes corrosion of the reactor to decrease durability, and also causes various process problems such as differential pressure occurrence and decreased process efficiency.

Conventionally, a technology of separating a crude oil feed by boiling point and then refining it has been performed, but since the waste plastic pyrolysis oil and the crude oil have different components and composition ratios from each other, when they are used in the refinement of the waste plastic pyrolysis oil as they are, impurity removal efficiency is deteriorated, and a separation process by boiling point is separately performed, which is inefficient from an economic point of view.

Therefore, a refining apparatus and a refining method of a waste plastic pyrolysis oil which may perform a hydrotreatment in a single reactor without a separation process by boiling point to effectively remove impurities.

### RELATED ART DOCUMENT

### [Patent Document]

Chinese Patent Laid-Open Publication No. 111171865 (May 19, 2020)

### DISCLOSURE

### Technical Problem

An object of the present invention is to provide a refining apparatus and a refining method of a waste plastic pyrolysis oil which may minimize the contents of chlorine (Cl) and nitrogen (N) in obtained refined oil.

Another object of the present invention is to provide a refining apparatus and a refining method of a waste plastic pyrolysis oil which may minimize the vol % of olefin in obtained refined oil.

### Technical Solution

In one general aspect, a refining apparatus of a waste plastic pyrolysis oil includes a reactor where a waste plastic pyrolysis oil is introduced and hydrotreated, wherein the reactor includes Area 1 including a hydrotreating catalyst having a Mo content of 1 to 15 wt % with respect to the total weight; and Area 2 including a hydrotreating catalyst having a Mo content of 5 to 40 wt % and a Ni or Co content of 4 to 50 wt % with respect to the total weight, and the waste plastic pyrolysis oil is refined by passing through Area 1 and Area 2 sequentially.

In an exemplary embodiment of the present disclosure, Area 1 may include Area 1-1 including a hydrotreating catalyst having a Mo content of 1 to 15 wt % with respect to the total weight; and Area 1-2 including a hydrotreating catalyst having a Mo content of 1 to 15 wt % and a Ni or Co content of 0.1 to 4 wt % with respect to the total weight, and the waste plastic pyrolysis oil may be refined by passing through Area 1-1 and Area 1-2 sequentially.

In an exemplary embodiment of the present disclosure, Area 2 may include Area 2-1 including a hydrotreating catalyst having a Mo content of 15 to 40 wt % and a Ni or Co content of 4 to 30 wt % with respect to the total weight; and Area 2-2 including a hydrotreating catalyst having a Mo content of 5 to 15 wt %, a Ni or Co content of 30 to 50 wt %, and a W content of 40 to 60 wt % with respect to the total weight, and a fluid discharged from Area 1-2 may be refined by passing through Area 2-1 and Area 2-2 sequentially.

In an exemplary embodiment of the present disclosure, the hydrotreating catalysts respectively in Area 1-1, Area 1-2, Area 2-1, and Area 2-2 includes 10 to 30 wt % of the hydrotreating catalysts in Area 1-1; 20 to 40 wt % of the hydrotreating catalysts in Area 1-2; 30 to 50 wt % of the hydrotreating catalysts in Area 2-1; and 5 to 15 wt % of the hydrotreating catalysts in Area 2-2 with respect to the total weight.

In an exemplary embodiment of the present disclosure, the hydrotreating catalysts of Area 1-1, Area 1-2, and Area 2-1 may be supported catalysts including a support.

In an exemplary embodiment of the present disclosure, the hydrotreating catalyst of Area 1-1 may include mesopores having a ratio of pores having a pore size of 100 to 200 Å of 50% or more, and may have an average pore size of 150 to 250 Å and an average pore volume of 0.7 to 2 ml/g.

In an exemplary embodiment of the present disclosure, the hydrotreating catalyst of Area 1-2 may include mesopores having a ratio of pores having a pore size of 80 to 150 Å of 50% or more, and may have an average pore size of 100 to 150 Å and an average pore volume of 0.4 to 0.8 ml/g.

In an exemplary embodiment of the present disclosure, the hydrotreating catalyst of Area 2-1 may include mesopores having a ratio of pores having a pore size of 50 to 100 Å of 50% or more, and may have an average pore size of 50 to 100 Å and an average pore volume of 0.1 to 0.5 ml/g.

In an exemplary embodiment of the present disclosure, the hydrotreating catalyst of Area 2-2 may have an average pore size of 10 to 50 Å and an average pore volume of 0.01 to 0.4 ml/g.

In an exemplary embodiment of the present disclosure, impurities included in a heavy hydrocarbon oil fraction in the waste plastic pyrolysis oil may be selectively removed in Area 1-1, and impurities included in a middle hydrocarbon oil fraction in the waste plastic pyrolysis oil may be selectively removed in Area 1-2.

In an exemplary embodiment of the present disclosure, impurities included in a light hydrocarbon oil fraction in the waste plastic pyrolysis oil may be selectively removed in Area 2-1, and an unsaturated double bond of the waste plastic pyrolysis oil may be selectively removed in Area 2-2.

In an exemplary embodiment of the present disclosure, the refining apparatus of a waste plastic pyrolysis oil may further include a guard bed, and the waste plastic pyrolysis oil may be hydrotreated in the guard bed and then introduced to the reactor.

In an exemplary embodiment of the present disclosure, the waste plastic pyrolysis oil refined by passing through Area 1 and Area 2 sequentially may include 10 ppm or less of chlorine and 30 ppm or less of nitrogen with respect to the total weight.

In another general aspect, a refining method of a waste plastic pyrolysis oil includes: Step 1 of hydrotreating a waste plastic pyrolysis oil in the presence of a hydrotreating catalyst having a Mo content of 1 to 15 wt % with respect to the total weight; and Step 2 of hydrotreating a fluid produced from Step 1 in the presence of a hydrotreating catalyst having a Mo content of 5 to 40 wt % and a Ni or Co content of 4 to 50 wt % with respect to the total weight.

In an exemplary embodiment of the present disclosure, Step 1 may include Step 1-1 of hydrotreating a waste plastic pyrolysis oil in the presence of a hydrotreating catalyst having a Mo content of 1 to 15 wt % with respect to the total weight; and Step 1-2 of hydrotreating a fluid produced from Step 1-1 in the presence of a hydrotreating catalyst having a Mo content of 1 to 15 wt % and a Ni or Co content of 0.1 to 4 wt % with respect to the total weight.

In an exemplary embodiment of the present disclosure, Step 2 may include Step 2-1 of hydrotreating a fluid produced from Step 1-2 in the presence of a hydrotreating catalyst having a Mo content of 15 to 40 wt % and a Ni or Co content of 4 to 30 wt % with respect to the total weight; and Step 2-2 of hydrotreating a fluid produced from Step 2-1 in the presence of a hydrotreating catalyst having a Mo content of 5 to 15 wt %, a Ni or Co content of 30 to 50 wt %, and a W content of 40 to 60 wt % with respect to the total weight.

In an exemplary embodiment of the present disclosure, the hydrotreating catalysts respectively in Step 1-1, Step 1-2, Step 2-1, and Step 2-2 includes 10 to 30 wt % of the hydrotreating catalysts in Step 1-1; 20 to 40 wt % of the hydrotreating catalysts in Step 1-2; 30 to 50 wt % of the hydrotreating catalysts in Step 2-1; and 5 to 15 wt % of the hydrotreating catalysts in Step 2-2 with respect to the total weight.

In an exemplary embodiment of the present disclosure, the hydrotreating catalysts of Step 1-1, Step 1-2, Step 2-1, and Step 2-2 may be supported catalysts including a support.

In an exemplary embodiment of the present disclosure, the hydrotreating catalyst of Step 1-1 may include mesopores having a ratio of pores having a pore size of 100 to 200 Å of 50% or more, and may have an average pore size of 150 to 250 Å and an average pore volume of 0.7 to 2 ml/g.

In an exemplary embodiment of the present disclosure, the hydrotreating catalyst of Step 1-2 may include mesopores having a ratio of pores having a pore size of 80 to 150 Å of 50% or more, and may have an average pore size of 100 to 150 Å and an average pore volume of 0.4 to 0.8 ml/g.

In an exemplary embodiment of the present disclosure, the hydrotreating catalyst of Step 2-1 may include mesopores having a ratio of pores having a pore size of 50 to 100 Å of 50% or more, and may have an average pore size of 50 to 100 Å and an average pore volume of 0.1 to 0.5 ml/g.

In an exemplary embodiment of the present disclosure, the hydrotreating catalyst of Step 2-2 may have an average pore size of 10 to 50 Å and an average pore volume of 0.01 to 0.4 ml/g.

In an exemplary embodiment of the present disclosure, a step of supplying a sulfur source to the hydrotreating catalyst may be further included before Step 1.

### Advantageous Effects

The refining apparatus and the refining method of a waste plastic pyrolysis oil according to the present disclosure may minimize the contents of chlorine (Cl) and nitrogen (N) in the obtained refined oil.

The refining apparatus and the refining method of a waste plastic pyrolysis oil according to the present disclosure may minimize the vol % of olefins in the obtained refined oil.

### DESCRIPTION OF DRAWINGS

The above and other objects, features and advantages of the present invention will become apparent from the following description of preferred embodiments given in conjunction with the accompanying drawings, in which:

FIG. 1 illustrates a refining apparatus of a waste plastic pyrolysis oil according to the present disclosure.

### BEST MODE

The drawings illustrated in the present specification are provided by way of example so that the idea of the present disclosure may be sufficiently conveyed to a person skilled in the art. Therefore, the present disclosure is not limited to the provided drawings, but may be embodied in many different forms, and the drawings may be exaggerated in order to clear the spirit of the present invention.

Technical terms and scientific terms used in the present specification have the general meaning understood by those skilled in the art to which the present invention pertains unless otherwise defined, and a description for the known function and configuration obscuring the gist of the present disclosure will be omitted in the following description and the accompanying drawings.

The singular form of the term used herein may be intended to also include a plural form, unless otherwise indicated.

The numerical range used in the present specification includes all values within the range including the lower limit and the upper limit, increments logically derived in a form and span in a defined range, all double limited values, and all possible combinations of the upper limit and the lower limit in the numerical range defined in different forms. Unless otherwise defined in the present specification, values which may be outside a numerical range due to experimental error or rounding of a value are also included in the defined numerical range.

The term “comprise” mentioned in the present specification is an open-ended description having a meaning equivalent to the term such as “is/are provided”, “contain”, “have”, “include”, or “is/are characterized”, and does not exclude elements, materials, or processes which are not further listed.

The unit of % used in the present specification without particular mention refers to wt % unless otherwise defined, and the unit of vol % (volume %) refers to vol % at 1 atm and 25° C.

The unit of ppm used in the present specification without particular mention refers to ppm by mass, unless otherwise defined.

The boiling point (bp) used in the present specification without particular mention refers to a boiling point at 1 atm.

In the present specification, Mo refers to a molybdenum metal, Ni is a nickel metal, Co is a cobalt metal, and W refers to a tungsten metal.

The wt % of a Mo, Ni, or Co metal component included in the hydrotreating catalyst mentioned in the present specification refers to the wt % to the total weight of the hydrotreating catalyst including a support and the metal component supported thereon.

Since a pyrolysis oil obtained by pyrolyzing waste plastics has a high content of impurities such as chlorine, nitrogen, and metal as compared with oil fractions manufactured from crude oil by a common method, it may not be directly used as high value-added petrochemical products such as gasoline and diesel oil and should go through a refining process.

The waste plastic pyrolysis oil is a mixture of hydrocarbon oil fractions having various boiling points and various molecular weight distributions, and the composition or the reaction activity of impurities in the pyrolysis oil may vary with the boiling point and the molecular weight distribution properties. When a refining process is performed on a waste plastic pyrolysis oil whole feed, an excessive hydrotreatment is performed under excessive operating conditions (high temperature, high pressure) due to a high content of impurities in the waste plastic pyrolysis oil, which activates the production of an ammonium salt (NH₄Cl). An ammonium salt (NH₄Cl) produced inside a reactor causes corrosion of the reactor to decrease durability, and also causes various process problems such as differential pressure occurrence and decreased process efficiency.

Thus, the present disclosure provides a refining apparatus of a waste plastic pyrolysis oil including a reactor where a waste plastic pyrolysis oil is introduced and hydrotreated, wherein the reactor includes Area 1 including a hydrotreating catalyst having a Mo content of 1 to 15 wt % with respect to the total weight; and Area 2 including a hydrotreating catalyst having a Mo content of 5 to 40 wt % and a Ni or Co content of 4 to 50 wt % with respect to the total weight, and the waste plastic pyrolysis oil is refined by passing through Area 1 and Area 2 sequentially.

The waste plastic pyrolysis oil may be a mixture of hydrocarbon oil fractions produced by pyrolyzing waste plastics, and the waste plastics may include solid or liquid wastes related to synthetic polymer compounds such as waste synthetic resin, waste synthetic fiber, waste synthetic rubber, and waste vinyl.

The waste plastic pyrolysis oil may be hydrocarbon oil fractions including, for example, 1 to 40 wt % of a first oil fraction having a boiling point of lower than 150° C., 1 to 50 wt % of a second oil fraction having a boiling point of 150° C. or higher and lower than 265° C., 1 to 50 wt % of a third oil fraction having a boiling point of 265° C. or higher and lower than 340° C., and 1 to 70 wt % of a fourth oil fraction having a boiling point of 340° C. or higher at 1 atm. Specifically, it may be a mixture of hydrocarbon oil fractions including 5 to 30 wt % of a first oil fraction having a boiling point of lower than 150° C., 15 to 40 wt % of a second oil fraction having a boiling point of 150° C. or higher and lower than 265° C., 25 to 30 wt % of a third oil fraction having a boiling point of 265° C. or higher and lower than 340° C., and 20 to 60 wt % of a fourth oil fraction having a boiling point of 340° C. or higher at 1 atm.

The mixture of hydrocarbon oil fractions may include impurities such as a chlorine compound, a nitrogen compound, and a metal compound, in addition to the hydrocarbon oil fraction, may include impurities in the form of a compound to which chlorine, nitrogen, or metal is bonded in the hydrocarbon, and may include hydrocarbons in the form of an olefin. The waste plastic pyrolysis oil may include 10 ppm or more of chlorine and 200 ppm or more of nitrogen with respect to the total weight. In addition, it may include 20 vol % or more of an olefin (1 atm, 25° C.) and 1 vol % or more (1 atm, 25° C.) of a conjugated diolefin. However, the content of impurities is only an example which may be included in the waste plastic pyrolysis oil, and the composition of the waste plastic pyrolysis oil is not necessarily limited thereto.

The reactor may include Area 1 including a hydrotreating catalyst having a Mo content of 1 to 15 wt % with respect to the total weight; and Area 2 including a hydrotreating catalyst having a Mo content of 5 to 40 wt % and a Ni or Co content of 4 to 50 wt % with respect to the total weight, and the waste plastic pyrolysis oil may be refined by passing through Area 1 and Area 2 sequentially. The waste plastic pyrolysis oil passes through the two areas provided with the hydrotreating catalysts having different compositions, respectively, thereby effectively removing impurities depending on the molecular weight distribution characteristics of the mixture of hydrocarbon oil fractions. In an exemplary embodiment of the present disclosure, the hydrotreating catalysts of Area 1 and Area 2 may be supported catalysts including a support.

In an exemplary embodiment of the present disclosure, Area 1 may include Area 1-1 including a hydrotreating catalyst having a Mo content of 1 to 15 wt % with respect to the total weight; and Area 1-2 including a hydrotreating catalyst having a Mo content of 1 to 15 wt % and a Ni or Co content of 0.1 to 4 wt % with respect to the total weight, and the waste plastic pyrolysis oil may be refined by passing through Area 1-1 and Area 1-2 sequentially. Specifically, Area 1-1 may include a hydrotreating catalyst having a Mo content of 5 to 10 wt % with respect to the total weight, and Area 1-2 may include a hydrotreating catalyst having a Mo content of 5 to 10 wt % and a Ni or Co content of 1 to 3 wt % with respect to the total weight.

When Area 1 includes Area 1-1 and Area 1-2, impurities may be more effectively removed depending on the molecular weight distribution characteristics of a mixture of hydrocarbon oil fractions, and in particular, impurities in a heavy hydrocarbon oil fraction may be selectively removed in Area 1-1 and impurities in a middle hydrocarbon oil fraction may be selectively removed in Area 1-2. The heavy hydrocarbon oil fraction may include a hydrocarbon oil fraction having a boiling point of 340° C. or higher in the waste plastic pyrolysis oil, and the middle hydrocarbon oil fraction may include a hydrocarbon oil fraction having a boiling point of 150 to 265° C., but these are only suggested as an example, and the present disclosure is not interpreted as being limited thereto.

In an exemplary embodiment of the present disclosure, Area 2 may include Area 2-1 including a hydrotreating catalyst having a Mo content of 15 to 40 wt % and a Ni or Co content of 4 to 30 wt % with respect to the total weight; and Area 2-2 including a hydrotreating catalyst having a Mo content of 5 to 15 wt %, a Ni or Co content of 30 to 50 wt %, and a W content of 40 to 60 wt % with respect to the total weight, and a fluid discharged from Area 1-2 may be refined by passing through Area 2-1 and Area 2-2 sequentially. Specifically, Area 2-1 may include a hydrotreating catalyst having a Mo content of 20 to 30 wt % and a Ni or Co content of 10 to 20 wt %, and Area 2-2 may include a hydrotreating catalyst having a Mo content of 7 to 13 wt %, a Ni or Co content of 35 to 45 wt %, and a W content of 45 to 55 wt %.

When Area 2 includes Area 2-1 and Area 2-2, impurities may be more effectively removed depending on the molecular weight distribution characteristics of a mixture of hydrocarbon oil fractions, and in particular, impurities in a light hydrocarbon oil fraction may be selectively removed in Area 2-1 and an unsaturated double bond in the waste plastic pyrolysis oil may be selectively removed in Area 2-2. The light hydrocarbon oil fraction may include a hydrocarbon oil fraction having a boiling point of 80 to 150° C., and the unsaturated double bond may include an olefin present in the waste plastic pyrolysis oil, but these are suggested as an example, and the present disclosure is not interpreted as being limited thereto.

A weight ratio of the hydrotreating catalyst in Area 1 and Area 2 may be 100:50 to 150, specifically 100:70 to 130. In addition, a weight ratio of the hydrotreating catalyst in Area 1-1 and Area 1-2 may be 100:70 to 200, specifically 100:100 to 150, and a weight ratio of the hydrotreating catalyst in Area 2-1 and Area 2-2 may be 100:10 to 60, specifically 100:20 to 40. When the weight ratio described above is satisfied, a selective impurity removal effect depending on the molecular weight distribution characteristics of the mixture of hydrocarbon oil fractions in each of the areas may be optimized.

In an exemplary embodiment of the present disclosure, The refining apparatus of a waste plastic pyrolysis oil of claim 3, the hydrotreating catalysts respectively in Area 1-1, Area 1-2, Area 2-1, and Area 2-2 includes 10 to 30 wt % of the hydrotreating catalysts in Area 1-1; 20 to 40 wt % of the hydrotreating catalysts in Area 1-2; 30 to 50 wt % of the hydrotreating catalysts in Area 2-1; and 5 to 15 wt % of the hydrotreating catalysts in Area 2-2 with respect to the total weight. When the range described above is satisfied, a selective impurity removal effect depending on the molecular weight distribution characteristics of the mixture of hydrocarbon oil fractions in each of the areas may be optimized. Specifically, the hydrotreating catalysts respectively includes 15 to 25 wt % of the hydrotreating catalysts in Area 1-1, 25 to 35 wt % of hydrotreating catalysts in Area 1-2, 35 to 45 wt % of hydrotreating catalysts in Area 2-1, and 7 to 13 wt % of hydrotreating catalysts in Area 2-2 with respect the total weight, and more specifically, 17 to 23 wt % of hydrotreating catalysts in Area 1-1, 27 to 33 wt % of hydrotreating catalysts in Area 1-2, 37 to 43 wt % of hydrotreating catalysts in Area 2-1, and 9 to 11 wt % of hydrotreating catalysts in Area 2-2, in the order of each of the areas, and may be used so that the total wt % of the hydrotreating catalysts in each of the areas satisfies 100 wt %.

In an exemplary embodiment of the present disclosure, the hydrotreating catalysts of Area 1-1, Area 1-2, and Area 2-1 may be supported catalysts including a support. Any support may be used as long as it has durability to support the active metal, and for example, may include any one or two or more selected from metals including any one or two or more selected from silicon, aluminum, zirconium, sodium, titanium, manganese, and the like; oxides of the metals; and carbon-based materials including any one or two or more selected from carbon black, active carbon, graphene, carbon nanotubes, graphite, and the like; and the like. However, the hydrotreating catalyst in Area 2-2 may be an unsupported catalyst including no support. In this case, a high olefin removal efficiency per same catalyst volume may be expected as compared with the supported catalyst, and since an operating temperature range is relatively broad, a high catalyst life may be expected.

In an exemplary embodiment of the present disclosure, the hydrotreating catalyst of Area 1-1 may include mesopores having a ratio of pores having a pore size of 100 to 200 Å of 50% or more, and may have an average pore size of 150 to 250 Å and an average pore volume of 0.7 to 2 ml/g. When the pore characteristics described above are satisfied, impurities may be effectively removed depending on the molecular weight distribution characteristics, and in particular, an effect of selectively removing impurities in a heavy hydrocarbon oil fraction may be improved. Specifically, it may include mesopores having a ratio of pores having a pore size of 120 to 180 Å of 50% or more, and may have an average pore size of 170 to 230 Å and an average pore volume of 1 to 1.5 ml/g.

In an exemplary embodiment of the present disclosure, the hydrotreating catalyst of Area 1-2 may include mesopores having a ratio of pores having a pore size of 80 to 150 Å of 50% or more, and may have an average pore size of 100 to 150 Å and an average pore volume of 0.4 to 0.8 ml/g. When the pore characteristics described above are satisfied, impurities may be effectively removed depending on the molecular weight distribution characteristics, and in particular, an effect of selectively removing impurities in a middle hydrocarbon oil fraction may be improved. Specifically, it may include mesopores having a ratio of pores having a pore size of 100 to 130 Å of 50% or more, and may have an average pore size of 110 to 140 Å and an average pore volume of 0.5 to 0.7 ml/g.

In an exemplary embodiment of the present disclosure, the hydrotreating catalyst of Area 2-1 may include mesopores having a ratio of pores having a pore size of 50 to 100 Å of 50% or more, and may have an average pore size of 50 to 100 Å and an average pore volume of 0.1 to 0.5 ml/g. When the pore characteristics described above are satisfied, impurities may be effectively removed depending on the molecular weight distribution characteristics, and in particular, an effect of selectively removing impurities in a light hydrocarbon oil fraction may be improved. Specifically, it may include mesopores having a ratio of pores having a pore size of 60 to 90 Å of 50% or more, and may have an average pore size of 60 to 90 Å and an average pore volume of 0.2 to 0.4 ml/g.

In an exemplary embodiment of the present disclosure, the hydrotreating catalyst of Area 2-2 may have an average pore size of 10 to 50 Å and an average pore volume of 0.01 to 0.4 ml/g. When the pore characteristics described above having almost no pore structure are satisfied, an effect of selectively removing an unsaturated double bond in the waste plastic pyrolysis oil may be improved, and since an operating temperature range is relatively broad, a high catalyst life may be expected. Specifically, it may have an average pore size of 20 to 40 Å and an average pore volume of 0.1 to 0.2 ml/g.

As the waste plastic pyrolysis oil and a hydrogen gas are introduced into the reactor including Area 1-1, Area 1-2, Area 2-1, and Area 2-2 and the waste plastic pyrolysis oil passes through the areas sequentially, the waste plastic pyrolysis oil is hydrotreated to remove impurities. Temperature conditions in the hydrotreatment in the reactor may be 250 to 400° C. It may be specifically 280° C. to 370° C., and more specifically 300° C. to 350° C. When the range is satisfied, hydrotreating reaction efficiency may be improved. However, this is only an example, and the present disclosure is not interpreted as being limited thereto.

A reaction pressure in the hydrotreatment in the reactor may be 200 bar or less. Specifically, in terms of further suppressing the production of an ammonium salt (NH₄Cl), the hydrotreatment may be performed at 150 bar or less, and 50 bar or more and 150 or less without limitation. However, this is only an example, and the present disclosure is not interpreted as being limited thereto.

In the hydrotreatment in the reactor, a liquid hourly space velocity (LHSV) may be 0.1 to 10 h⁻¹. When LHSV satisfies the range, a refined oil from which impurities such as chlorine, nitrogen, or metal have been removed may be more stably obtained. Specifically, it may be 0.5 to 9 h-1, more specifically 1 to 7 h⁻¹. However, this is only an example, and the present disclosure is not interpreted as being limited thereto.

Any supply flow ratio of the waste plastic pyrolysis oil and a hydrogen gas introduced to the reactor may be used as long as the hydrotreatment is performed, and for example, a volume flow ratio at 1 atm may be 1:300 to 3,000, specifically, 1:500 to 2,500. However, this is only an example, and the present disclosure is not interpreted as being limited thereto.

In an exemplary embodiment of the present disclosure, impurities included in a heavy hydrocarbon oil fraction in the waste plastic pyrolysis oil may be selectively removed in Area 1-1, and impurities included in a middle hydrocarbon oil fraction in the waste plastic pyrolysis oil may be selectively removed in Area 1-2. As described above, Area 1-1 includes mesopores having a Mo content of 1 to 15 wt % and a ratio of pores having a pore size of 100 to 200 Å of 50% or more, and includes a hydrotreating catalyst supported on a support having an average pore size of 150 to 250 Å and an average pore volume of 0.7 to 2 ml/g, thereby selectively removing impurities included in a heavy hydrocarbon oil fraction in the waste plastic pyrolysis oil. Area 1-2 includes mesopores having a Mo content of 1 to 15 wt %, a Ni or Co content of 0.1 to 4 wt %, and a ratio of pores having a pore size of 80 to 150 Å of 50% or more, and includes a hydrotreating catalyst supported on a support having an average pore size of 100 to 150 Å and an average pore volume of 0.4 to 0.8 ml/g, thereby selectively removing impurities included in a middle hydrocarbon oil fraction in the waste plastic pyrolysis oil.

In an exemplary embodiment of the present disclosure, impurities included in a light hydrocarbon oil fraction in the waste plastic pyrolysis oil may be selectively removed in Area 2-1, and an unsaturated double bond of the waste plastic pyrolysis oil may be selectively removed in Area 2-2. As described above, Area 2-1 includes mesopores having a Mo content of 15 to 40 wt %, a Ni or Co content of 4 to 30 wt %, and a ratio of pores having a pore size of 50 to 100 Å of 50% or more, and includes a hydrotreating catalyst supported on a support having an average pore size of 50 to 100 Å and an average pore volume of 0.1 to 0.5 ml/g, thereby selectively removing impurities included in a light hydrocarbon oil fraction in the waste plastic pyrolysis oil. Area 2-2 includes an unsupported hydrotreating catalyst which has a Mo content of 5 to 15 wt %, a Ni or Co content of 30 to 50 wt %, and a W content of 40 to 60 wt %, and an average pore size of 10 to 50 Å and an average pore volume of 0.01 to 0.4 ml/g, has almost no pore structure in a support, and is not supported in a support, thereby selectively removing an unsaturated double bond of the waste plastic pyrolysis oil.

In an exemplary embodiment of the present disclosure, the refining apparatus of a waste plastic pyrolysis oil may further include a guard bed, and the waste plastic pyrolysis oil may be hydrotreated in the guard bed and then introduced to the reactor. The waste plastic pyrolysis oil is hydrotreated in the guard bed and then introduced to the reactor, thereby improving the stability of a refining process. The guard bed includes a hydrotreating catalyst, and the hydrotreating catalyst in the guard bed may include any one or two or more selected from a hydrodesulfurization catalyst, a hydrodenitrification catalyst, a hydrodechlorination catalyst, a hydrodemetallization catalyst, and the like. The catalyst allows the denitrification reaction or the dechlorination reaction to be performed depending on the conditions such as temperature described above also, while a demetallization reaction is performed. More specifically, the hydrotreating catalyst may include an active metal having hydrotreating catalytic ability, and preferably, may have an active metal supported on a support. The reaction conditions such as temperature and pressure of the guard bed may refer to the reaction conditions of the reactor described above.

In an exemplary embodiment of the present disclosure, the waste plastic pyrolysis oil refined by passing through Area 1 and Area 2 sequentially may include 10 ppm or less of chlorine and 30 ppm or less of nitrogen with respect to the total weight. Specifically, it may include 5 ppm or less of chlorine and 20 ppm or less of nitrogen. As described above, since the waste plastic pyrolysis oil is a mixture of hydrocarbon oil fractions having various boiling points and various molecular weight distributions, it passes through Area 1 and Area 2, specifically Area 1-1, Area 1-2, Area 2-1, and Area 2-2 sequentially, thereby selectively removing impurities depending on the molecular weight characteristics to optimize impurity removal efficiency to minimize the content of impurities in the obtained refined oil.

In addition, the present disclosure provides a refining method of a waste plastic pyrolysis oil including: Step 1 of hydrotreating a waste plastic pyrolysis oil in the presence of a hydrotreating catalyst having a Mo content of 1 to 15 wt % with respect to the total weight; and Step 2 of hydrotreating a fluid produced from Step 1 in the presence of a hydrotreating catalyst having a Mo content of 5 to 40 wt % and a Ni or Co content of 4 to 50 wt % with respect to the total weight.

As described above, the waste plastic pyrolysis oil is a mixture of hydrocarbon oil fractions having various boiling points and various molecular weight distributions, may include impurities such as a chlorine compound, a nitrogen compound, and a metal compound, may include impurities in the form a compound to which chlorine, nitrogen, or metal is bonded in the hydrocarbon, and may include hydrocarbons in the form of an olefin. The waste plastic pyrolysis oil is hydrotreated continuously in Step 1 and Step 2 in the presence of hydrotreating catalysts having different compositions, thereby effectively removing impurities depending on the molecular weight distribution characteristics of the mixture of hydrocarbon oil fractions.

In an exemplary embodiment of the present disclosure, Step 1 may include Step 1-1 of hydrotreating a waste plastic pyrolysis oil in the presence of a hydrotreating catalyst having a Mo content of 1 to 15 wt % with respect to the total weight; and Step 1-2 of hydrotreating a fluid produced from Step 1-1 in the presence of a hydrotreating catalyst having a Mo content of 1 to 15 wt % and a Ni or Co content of 0.1 to 4 wt % with respect to the total weight. When Step 1 includes Step 1-1 and Step 1-2, impurities may be more effectively removed depending on the molecular weight distribution characteristics of the mixture of hydrocarbon oil fractions, and in particular, impurities in a heavy hydrocarbon oil fraction may be selectively removed in Step 1-1 and impurities in a middle hydrocarbon oil fraction may be selectively removed in Step 1-2.

In an exemplary embodiment of the present disclosure, Step 2 may include Step 2-1 of hydrotreating a fluid produced from Step 1-2 in the presence of a hydrotreating catalyst having a Mo content of 15 to 40 wt % and a Ni or Co content of 4 to 30 wt % with respect to the total weight; and Step 2-2 of hydrotreating a fluid produced from Step 2-1 in the presence of a hydrotreating catalyst having a Mo content of 5 to 15 wt %, a Ni or Co content of 30 to 50 wt %, and a W content of 40 to 60 wt % with respect to the total weight. When Step 2 includes Step 2-1 and Step 2-2, impurities may be more effectively removed depending on the molecular weight distribution characteristics of the mixture of hydrocarbon oil fractions, and in particular, impurities in a light hydrocarbon oil fraction may be selectively removed in Step 2-1 and an unsaturated double bond in the waste plastic pyrolysis oil may be selectively removed in Step 2-2.

A weight ratio of the hydrotreating catalyst in Step 1 and Step 2 may be 100:50 to 150, specifically 100:70 to 130. In addition, a weight ratio of the hydrotreating catalyst in Step 1-1 and Step 1-2 may be 100:70 to 200, specifically 100:100 to 150, and a weight ratio of the hydrotreating catalyst in Step 2-1 and Step 2-2 may be 100:10 to 60, specifically 100:20 to 40. When the weight ratio described above is satisfied, a selective impurity removal effect depending on the molecular weight distribution characteristics of the mixture of hydrocarbon oil fractions in each of the steps may be optimized.

In an exemplary embodiment of the present disclosure, The refining apparatus of a waste plastic pyrolysis oil of claim 16,

the hydrotreating catalysts respectively in Step 1-1, Step 1-2, Step 2-1, and Step 2-2 includes 10 to 30 wt % of the hydrotreating catalysts in Step 1-1; 20 to 40 wt % of the hydrotreating catalysts in Step 1-2; 30 to 50 wt % of the hydrotreating catalysts in Step 2-1; and 5 to 15 wt % of the hydrotreating catalysts in Step 2-2 with respect to the total weight. When the range described above is satisfied, a selective impurity removal effect depending on the molecular weight distribution characteristics of the mixture of hydrocarbon oil fractions in each of the steps may be optimized. Specifically, the hydrotreating catalysts respectively includes 15 to 25 wt % of the hydrotreating catalysts in Step 1-1, 25 to 35 wt % of the hydrotreating catalysts in Step 1-2, 35 to 45 wt % of the hydrotreating catalysts in Step 2-1, and 7 to 13 wt % of the hydrotreating catalysts in Step 2-2, and more specifically, 17 to 23 wt % of the hydrotreating catalysts in Step 1-1, 27 to 33 wt % of the hydrotreating catalysts in Step 1-2, 37 to 43 wt % of the hydrotreating catalysts in Step 2-1, and 9 to 11 wt % of the hydrotreating catalysts in Step 2-2, in the order of each of the steps, and may be used so that the total wt of the hydrotreating catalysts in each of the steps satisfies 100 wt %.

In an exemplary embodiment of the present disclosure, the hydrotreating catalysts of Step 1-1, Step 1-2, Step 2-1, and Step 2-2 may be supported catalysts including a support. Any support may be used as long as it has durability to support the active metal, and for example, may include any one or two or more selected from metals including any one or two or more selected from silicon, aluminum, zirconium, sodium, titanium, manganese, and the like; oxides of the metals; and carbon-based materials including any one or two or more selected from carbon black, active carbon, graphene, carbon nanotubes, graphite, and the like; and the like. However, the hydrotreating catalyst in Step 2-2 may be an unsupported catalyst including no support. In this case, a high olefin removal efficiency per same catalyst volume may be expected as compared with a supported catalyst, and since an operating temperature range is relatively broad, a high catalyst life may be expected.

In an exemplary embodiment of the present disclosure, the hydrotreating catalyst of Step 1-1 may include mesopores having a ratio of pores having a pore size of 100 to 200 Å of 50% or more, and may have an average pore size of 150 to 250 Å and an average pore volume of 0.7 to 2 ml/g. When the pore characteristics described above are satisfied, impurities may be effectively removed depending on the molecular weight distribution characteristics, and in particular, an effect of selectively removing impurities in a heavy hydrocarbon oil fraction may be improved. Specifically, it may include mesopores having a ratio of pores having a pore size of 120 to 180 Å of 50% or more, and may have an average pore size of 170 to 230 Å and an average pore volume of 1 to 1.5 ml/g.

In an exemplary embodiment of the present disclosure, the hydrotreating catalyst of Step 1-2 may include mesopores having a ratio of pores having a pore size of 80 to 150 Å of 50% or more, and may have an average pore size of 100 to 150 Å and an average pore volume of 0.4 to 0.8 ml/g. When the pore characteristics described above are satisfied, impurities may be effectively removed depending on the molecular weight distribution characteristics, and in particular, an effect of selectively removing impurities in a middle hydrocarbon oil fraction may be improved. Specifically, it may include mesopores having a ratio of pores having a pore size of 100 to 130 Å of 50% or more, and may have an average pore size of 110 to 140 Å and an average pore volume of 0.5 to 0.7 ml/g.

In an exemplary embodiment of the present disclosure, the hydrotreating catalyst of Step 2-1 may include mesopores having a ratio of pores having a pore size of 50 to 100 Å of 50% or more, and may have an average pore size of 50 to 100 Å and an average pore volume of 0.1 to 0.5 ml/g. When the pore characteristics described above are satisfied, impurities may be effectively removed depending on the molecular weight distribution characteristics, and in particular, an effect of selectively removing impurities in a light hydrocarbon oil fraction may be improved. Specifically, it may include mesopores having a ratio of pores having a pore size of 60 to 90 Å of 50% or more, and may have an average pore size of 60 to 90 Å and an average pore volume of 0.2 to 0.4 ml/g.

In an exemplary embodiment of the present disclosure, the hydrotreating catalyst of Step 2-2 may have an average pore size of 10 to 50 Å and an average pore volume of 0.01 to 0.4 ml/g. When the pore characteristics described above having almost no pore structure are satisfied, an effect of selectively removing an unsaturated double bond in the waste plastic pyrolysis oil may be improved, and since an operating temperature range is relatively broad, a high catalyst life may be expected. Specifically, it may have an average pore size of 20 to 40 Å and an average pore volume of 0.1 to 0.2 ml/g.

In an exemplary embodiment of the present disclosure, a step of supplying a sulfur source to the hydrotreating catalyst may be further included before Step 1. The sulfur source refers to a sulfur source which may continuously supply a sulfur source during a refining process. The sulfur source is supplied to the hydrotreating catalyst, thereby suppressing the deactivation of the hydrotreating catalyst due to the lack of the sulfur source and operation at a high temperature and maintaining catalytic activity.

The sulfur source may include a sulfur-containing petroleum-based oil fraction and a sulfur-containing organic compound. The sulfur-containing petroleum-based oil fraction refers to an oil fraction formed of a hydrocarbon containing sulfur obtained using crude oil as a raw material. It is not particularly limited as long as it is an oil fraction containing sulfur, and may be, for example, light gas oil, straight naphtha, decompression naphtha, pyrolysis naphtha, straight kerosene, decompression kerosene, pyrolysis kerosene, straight diesel, decompression diesel, pyrolysis diesel, and the like, or any mixture thereof. The sulfur-containing organic compound may include one or two or more sulfur-containing organic compounds selected from a disulfide-based compound, a sulfide-based compound, a sulfonate-based compound, and a sulfate-based compound. This is only presented as an example, and the present disclosure is not interpreted as being limited thereto.

The sulfur source may include 1 wt % or more of sulfur. When the sulfur component is included at 1 wt % or less, the content of the sulfur component supplied is small, so that the effect of preventing the deactivation of the molybdenum-based hydrotreating catalyst may be insignificant. Specifically, the sulfur component may be included at 5 wt % or more, more specifically 10 wt % or more, and unlimitedly 20 wt % or less.

For the matters which are not further described in the refining method of a waste plastic pyrolysis oil, see the descriptions for the refining apparatus of a waste plastic pyrolysis oil described above.

Hereinafter, the present disclosure will be described in detail by the examples, however, the examples are for describing the present disclosure in more detail, and the right scope is not limited to the following examples.

### Example 1

A waste plastic was pyrolyzed to obtain a waste plastic pyrolysis oil containing a high content of impurities of 420 ppm of nitrogen (N), 132 ppm of chlorine (Cl), 18 vol % of olefin, and 2.3 wt % of conjugated diolefin, which was used as a raw material (feed).

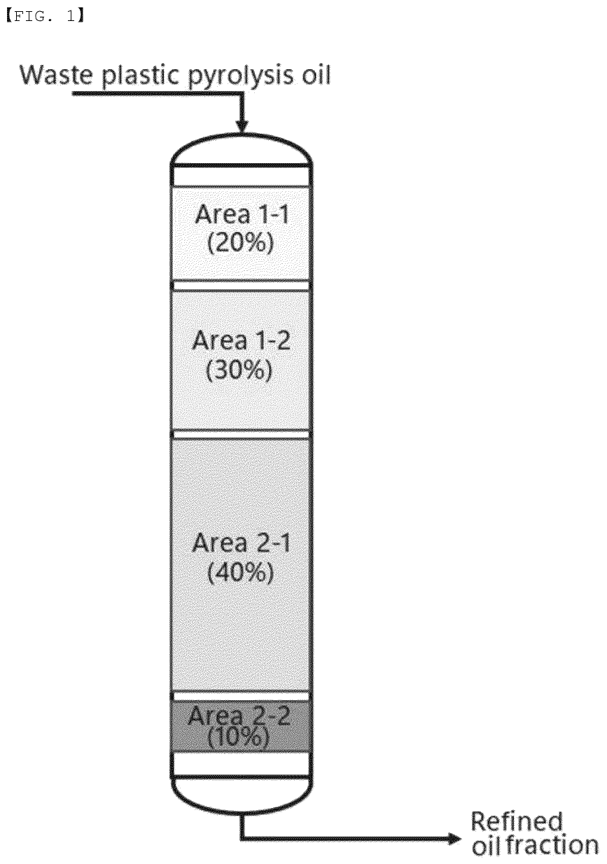

As shown in FIG. 1, an apparatus provided with Area 1-1, Area 1-2, Area 2-1, and Area 2-2 in a reactor was designed. The properties of the hydrotreating catalysts included in each area are shown in the following Table 1.

TABLE 1

| | | | | | | | Hydrotreating catalyst pore | | |
|---|---|---|---|---|---|---|---|---|---|
| | | Hydrotreating | | | | | characteristics | | |
| | Hydrotreating | catalyst | | | | | | | Average |
| | catalyst | composition | | | | | Surface | Pore | Pore |
| | weight | ratio | | | | Support | Area | volume | diameter |
| | (g) | NiO | MoO₃ | P₂O₅ | WO₃ | Al₂O₃ | (m²/g) | (cc/g) | (Å) |
| Area 1-1 | 20 | | 8 | | | 92 | 190.4 | 0.797 | 167.4 |
| Area 1-2 | 30 | 2 | 8 | 3 | | 87 | 198 | 0.622 | 125.7 |
| Area 2-1 | 40 | 11 | 29 | 7 | | 53 | 181.9 | 0.34 | 76.8 |
| Area 2-2 | 10 | 37.3 | 9.8 | | 52.9 | | 161.2 | 0.13 | 31.2 |

A waste plastic pyrolysis oil and a hydrogen gas were introduced into the reactor. The waste plastic pyrolysis oil was passed through the areas sequentially under the conditions of 350° C., 160 bar, H₂/oil ratio or 840, and LHSV of 0.4 h⁻¹ to perform a hydrotreatment. A waste plastic pyrolysis oil which had been refined from impurities was finally obtained.

### Example 2

A waste plastic pyrolysis oil which had been refined from impurities was obtained in the same manner as in Example 1 except that the reaction was performed under the conditions of 300° C. and 130 bar.

### Example 3

A waste plastic pyrolysis oil which had been refined from impurities was obtained in the same manner as in Example 1 except that the reaction was performed by changing the weight (g) of the hydrotreating catalyst to 15 g in Area 1-1, 25 g in Area 1-2, 45 g in Area 2-1, and 15 g in Area 2-2.

### Example 4

A waste plastic pyrolysis oil which had been refined from impurities was obtained in the same manner as in Example 1 except that the composition ratio of the hydrotreating catalyst was changed as in the following Table 2.

TABLE 2

| | Hydrotreating catalyst | | | | |
|---|---|---|---|---|---|
| | composition ratio | | | | Support |
| Example 4 | NiO | MoO₃ | P₂O₅ | WO₃ | Al₂O₃ |
| Area 1-1 | | 11 | | | 89 |
| Area 1-2 | 3.5 | 13 | 2 | | 81.5 |
| Area 2-1 | 21 | 35 | 5 | | 39 |
| Area 2-2 | 32 | 14 | | 54 | |

### Comparative Example 1

A waste plastic pyrolysis oil which had been refined from impurities was obtained in the same manner as in Example 1 except that the hydrotreating catalyst of Area 1-2 was applied to Area 1-1 to use a total of 50 g of the hydrotreating catalyst.

### Comparative Example 2

A waste plastic pyrolysis oil which had been refined from impurities was obtained in the same manner as in Example 1 except that the hydrotreating catalyst of Area 1-1 was applied to Area 1-2 to use a total of 50 g of the hydrotreating catalyst.

### Comparative Example 3

A waste plastic pyrolysis oil which had been refined from impurities was obtained in the same manner as in Example 1 except that the hydrotreating catalyst of Area 2-2 was applied to Area 2-1 to use a total of 50 g of the hydrotreating catalyst.

### Comparative Example 4

A waste plastic pyrolysis oil which had been refined from impurities was obtained in the same manner as in Example 1 except that the hydrotreating catalyst of Area 2-1 was applied to Area 2-2 to use a total of 50 g of the hydrotreating catalyst.

### Comparative Example 5

A waste plastic pyrolysis oil which had been refined from impurities was obtained in the same manner as in Example 1 except that the refining apparatus was designed in the order of Area 1-1, Area 1-2, Area 2-2, and Area 2-1.

The reaction conditions of Examples 1 to 4 and Comparative Examples 1 to 5 are summarized in the following Table 3.

TABLE 3

| | | | | | | Comparative | Camparative | Comparative | Comparative | Comparative |
|---|---|---|---|---|---|---|---|---|---|---|
| | | Example 1 | Example 2 | Example 3 | Example 4 | Example 1 | Example 2 | Example 3 | Example 4 | Example 5 |
| Hydrotreating | Area 1-1 | 20 | 20 | 15 | 20 | Area 1-2 | Area 1-1 | 20 | 20 | 20 |
| catalyst | Area 1-2 | 30 | 30 | 25 | 30 | 50 | 50 | 30 | 30 | 30 |
| weight | Area 2-1 | 40 | 40 | 45 | 40 | 40 | 40 | Area 2-2 | Area 2-1 | Area 2-2 |
| (g) | Area 2-2 | 10 | 10 | 15 | 10 | 10 | 10 | 50 | 50 | 10 |
| | | | | | | | | | | Area 2-1 |
| | | | | | | | | | | 40 |
| Reaction | | 350 | 300 | 350 | 350 | 350 | 350 | 350 | 350 | 350 |
| temperature | | | | | | | | | | |
| (° C.) | | | | | | | | | | |
| Reaction | | 160 | 130 | 160 | 160 | 160 | 160 | 160 | 160 | 160 |
| pressure | | | | | | | | | | |
| (bar) | | | | | | | | | | |

### Evaluation Example

### Measurement Method

A chlorine (Cl) content (ppm) and a nitrogen (N) content (ppm) in the finally refined waste plastic pyrolysis oil were measured by ICP and XRF analysis.

The olefin vol % in the finally refined waste plastic pyrolysis oil was measured by Bromine index analysis.

### Chlorine (Cl) and Nitrogen (N) Contents

The results of analyzing the contents of chlorine (Cl) and nitrogen (N) contents of Examples 1 to 4 and Comparative Examples 1 to 3 are shown in the following Table 4.

TABLE 4

| | Pyrolysis | | | | | Comparative | Comparative | Comparative |
|---|---|---|---|---|---|---|---|---|
| | oil feed | Example 1 | Example 2 | Example 3 | Example 4 | Example 1 | Example 2 | Example 3 |
| Cl (ppm) | 132 | <1 | <1 | 2 | <1 | 8 | 10 | 27 |
| N (ppm) | 420 | 19 | 25 | 35 | 13 | 26 | 25 | 59 |

In Examples 1 to 4, it was confirmed that the contents of chlorine (Cl) and nitrogen (N) in the finally refined waste plastic pyrolysis oil were minimized, and in particular, chlorine (Cl) was removed to the level of a few ppm.

However, in Comparative Examples 1 and 2, it was confirmed that the chlorine (Cl) content was measured as 8 ppm or more, and thus, was not sufficiently removed. This shows that since in Area 1 of the reactor, the waste plastic pyrolysis oil was removed only in one area selected from Area 1-1 and Area 1-2, impurity removal efficiency was decreased.

In particular, in Comparative Example 3, both the chlorine (Cl) and the nitrogen (N) contents were measured as being high, and this shows that since in Area 2 of the reactor, the waste plastic pyrolysis oil was refined only in Area 2-2, impurity removal efficiency was decreased.

### Olefin Vol %

The results of analyzing the olefin vol % of Examples 1 to 3 and Comparative Examples 4 and 5 are shown in the following Table 5.

TABLE 5

| | Pyrolysis | | | | Comparative | Comparative |
|---|---|---|---|---|---|---|
| | oil feed | Example 1 | Example 2 | Example 3 | Example 4 | Example 5 |
| Olefin | 18 | N.D. | N.D. | N.D. | 0.1 | 0.1 |
| (vol %) | | | | | | |

In Examples 1 to 3, it was confirmed that the olefin vol % in the finally refined waste plastic pyrolysis oil was minimized.

However, in Comparative Example 4, 0.1 vol % of an olefin was measured in the waste plastic pyrolysis oil. This shows that since in Area 2, the waste plastic pyrolysis oil was refined only in Area 2-1, olefin removal efficiency was decreased.

In addition, in Comparative Example 5 also, 0.1 vol % of an olefin was measured, and this shows that since the waste plastic pyrolysis oil was refined by passing through Area 2-1 and Area 2-2 sequentially, but was refined in the order of Area 2-2 and Area 2-1, olefin removal efficiency was decreased.

Although the exemplary embodiments of the present invention have been described above, the present invention is not limited to the exemplary embodiments but may be made in various forms different from each other, and those skilled in the art will understand that the present invention may be implemented in other specific forms without departing from the spirit or essential feature of the present invention. Therefore, it should be understood that the exemplary embodiments described above are not restrictive, but illustrative in all aspects.

1. A refining apparatus of a waste plastic pyrolysis oil comprising a reactor where a waste plastic pyrolysis oil is introduced and hydrogenated,
wherein the reactor includes Area 1 including a hydrotreating catalyst having a Mo content of 1 to 15 wt % with respect to the total weight; and Area 2 including a hydrotreating catalyst having a Mo content of 5 to 40 wt % and a Ni or Co content of 4 to 50 wt % with respect to the total weight, and
the waste plastic pyrolysis oil is refined by passing through Area 1 and Area 2 sequentially.

2. The refining apparatus of a waste plastic pyrolysis oil of claim 1,
wherein Area 1 includes Area 1-1 including a hydrotreating catalyst having a Mo content of 1 to 15 wt % with respect to the total weight; and Area 1-2 including a hydrotreating catalyst having a Mo content of 1 to 15 wt % and a Ni or Co content of 0.1 to 4 wt % with respect to the total weight, and
the waste plastic pyrolysis oil is refined by passing through Area 1-1 and Area 1-2 sequentially.

3. The refining apparatus of a waste plastic pyrolysis oil of claim 2,
wherein Area 2 includes Area 2-1 including a hydrotreating catalyst having a Mo content of 15 to 40 wt % and a Ni or Co content of 4 to 30 wt % with respect to the total weight; and Area 2-2 including a hydrotreating catalyst having a Mo content of 5 to 15 wt %, a Ni or Co content of 30 to 50 wt %, and a W content of 40 to 60 wt % with respect to the total weight, and
a fluid discharged from Area 1-2 is refined by passing through Area 2-1 and Area 2-2 sequentially.

4. The refining apparatus of a waste plastic pyrolysis oil of claim 3, the hydrotreating catalysts respectively in Area 1-1, Area 1-2, Area 2-1, and Area 2-2 includes 10 to 30 wt % of the hydrotreating catalysts in Area 1-1; 20 to 40 wt % of the hydrotreating catalysts in Area 1-2; 30 to 50 wt % of the hydrotreating catalysts in Area 2-1; and 5 to 15 wt % of the hydrotreating catalysts in Area 2-2 with respect to the total weight.

5. (canceled)

6. The refining apparatus of a waste plastic pyrolysis oil of claim 2, wherein the hydrotreating catalyst of Area 1-1 includes mesopores having a ratio of pores having a pore size of 100 to 200 Å of 50% or more, and has an average pore size of 150 to 250 Å and an average pore volume of 0.7 to 2 ml/g.

7. The refining apparatus of a waste plastic pyrolysis oil of claim 2, wherein the hydrotreating catalyst of Area 1-2 includes mesopores having a ratio of pores having a pore size of 80 to 150 Å of 50% or more, and has an average pore size of 100 to 150 Å and an average pore volume of 0.4 to 0.8 ml/g.

8. The refining apparatus of a waste plastic pyrolysis oil of claim 3, wherein the hydrotreating catalyst of Area 2-1 includes mesopores having a ratio of pores having a pore size of 50 to 100 Å of 50% or more, and has an average pore size of 50 to 100 Å and an average pore volume of 0.1 to 0.5 ml/g.

9. The refining apparatus of a waste plastic pyrolysis oil of claim 3, wherein the hydrotreating catalyst of Area 2-2 has an average pore size of 10 to 50 Å and an average pore volume of 0.01 to 0.4 ml/g.

10. The refining apparatus of a waste plastic pyrolysis oil of claim 2, wherein impurities included in a heavy hydrocarbon oil fraction in the waste plastic pyrolysis oil are selectively removed in Area 1-1, and impurities included in a middle hydrocarbon oil fraction in the waste plastic pyrolysis oil are selectively removed in Area 1-2.

11. The refining apparatus of a waste plastic pyrolysis oil of claim 3, wherein impurities included in a light hydrocarbon oil fraction in the waste plastic pyrolysis oil are selectively removed in Area 2-1, and an unsaturated double bond of the waste plastic pyrolysis oil is selectively removed in Area 2-2.

12. The refining apparatus of a waste plastic pyrolysis oil of claim 1, further comprising a guard bed, wherein the waste plastic pyrolysis oil is hydrotreated in the guard bed and then introduced to the reactor.

13. (canceled)

14. A refining method of a waste plastic pyrolysis oil, the method comprising:
Step 1 of hydrotreating a waste plastic pyrolysis oil in the presence of a hydrotreating catalyst having a Mo content of 1 to 15 wt % with respect to the total weight; and
Step 2 of hydrotreating a fluid produced from Step 1 in the presence of a hydrotreating catalyst having a Mo content of 5 to 40 wt % and a Ni or Co content of 4 to 50 wt % with respect to the total weight.

15. The refining method of a waste plastic pyrolysis oil of claim 14,
wherein Step 1 includes:
Step 1-1 of hydrotreating a waste plastic pyrolysis oil in the presence of a hydrotreating catalyst having a Mo content of 1 to 15 wt % with respect to the total weight; and
Step 1-2 of hydrotreating a fluid produced from Step 1-1 in the presence of a hydrotreating catalyst having a Mo content of 1 to 15 wt % and a Ni or Co content of 0.1 to 4 wt % with respect to the total weight.

16. The refining method of a waste plastic pyrolysis oil of claim 15,
wherein Step 2 includes:
Step 2-1 of hydrotreating a fluid produced from Step 1-2 in the presence of a hydrotreating catalyst having a Mo content of 15 to 40 wt % and a Ni or Co content of 4 to 30 wt % with respect to the total weight; and
Step 2-2 of hydrotreating a fluid produced from Step 2-1 in the presence of a hydrotreating catalyst having a Mo content of 5 to 15 wt %, a Ni or Co content of 30 to 50 wt %, and a W content of 40 to 60 wt % with respect to the total weight.

17. The refining apparatus of a waste plastic pyrolysis oil of claim 16,
the hydrotreating catalysts respectively in Step 1-1, Step 1-2, Step 2-1, and Step 2-2 includes 10 to 30 wt % of the hydrotreating catalysts in Step 1-1; 20 to 40 wt % of the hydrotreating catalysts in Step 1-2; 30 to 50 wt % of the hydrotreating catalysts in Step 2-1; and 5 to 15 wt % of the hydrotreating catalysts in Step 2-2 with respect to the total weight.

18. (canceled)

19. The refining method of a waste plastic pyrolysis oil of claim 15, wherein the hydrotreating catalyst of Step 1-1 includes mesopores having a ratio of pores having a pore size of 100 to 200 Å of 50% or more, and has an average pore size of 150 to 250 Å and an average pore volume of 0.7 to 2 ml/g.

20. The refining method of a waste plastic pyrolysis oil of claim 15, wherein the hydrotreating catalyst of Step 1-2 includes mesopores having a ratio of pores having a pore size of 80 to 150 Å of 50% or more, and has an average pore size of 100 to 150 Å and an average pore volume of 0.4 to 0.8 ml/g.

21. The refining method of a waste plastic pyrolysis oil of claim 16, wherein the hydrotreating catalyst of Step 2-1 includes mesopores having a ratio of pores having a pore size of 50 to 100 Å of 50% or more, and has an average pore size of 50 to 100 Å and an average pore volume of 0.1 to 0.5 ml/g.

22. The refining method of a waste plastic pyrolysis oil of claim 16, wherein the hydrotreating catalyst of Step 2-2 has an average pore size of 10 to 50 Å and an average pore volume of 0.01 to 0.4 ml/g.

23. The refining method of a waste plastic pyrolysis oil of claim 14, further comprising: supplying a sulfur source to the hydrotreating catalyst before Step 1.
